(19) United States
(12) Patent Application Publication
(10) Pub. No.: US 2002/0175063 A1
(43) Pub. Date: Nov. 28, 2002

(54) Keyswitch having a keytop that is upwardly and downwardly movable and method of assembling the same

(75) Inventors: Takayuki Ito, Fukushima-ken (JP); Tsuyoshi Narusawa, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/918,926

(22) Filed: Jul. 31, 2001

(30) Foreign Application Priority Data
Aug. 7, 2000 (JP) 2000-244045
Aug. 7, 2000 (JP) 2000-244047

(51) Int. Cl. H01H 13/70

(52) U.S. Cl. 200/344

(57) ABSTRACT

A keyswitch including a lever mounting plate with which the bottom ends of a pair of levers can engage, and an actuator with which the top ends of the pair of levers can engage. The lever mounting plate is mounted to a holding plate, and is placed on a membrane switch. The actuator is mounted to the keytop. The lever mounting plate and the actuator each include a rotation engaging section and a slide engaging section. The rotation engaging section has an open portion and allows a rotating pin of one of lever members to rotatably engage therewith. The slide engaging section has an open portion, and allows a slide pin of the other lever member to engage therewith. The open portion of the rotation engaging section and that of the slide engaging section open in the same direction so that the pair of lever members can be mounted to the lever mounting plate and to the actuator by only moving the pair of lever members from one side to the other.

### BACKGROUND OF THE INVENTION

1. Field of the Invention

The present invention relates to a keyswitch for use in a keyboard device, and more particularly, to a keyswitch having a keytop that is upwardly and downwardly movable. In addition, the present invention relates to a method of assembling the keyswitch.

2. Description of the Related Art

In recent years, keyswitches suitable for use in keyboard input devices have been proposed in which the top ends of a pair of lever members linked so as to cross each other are supported at a keytop, and, with the upward and downward movement of the keytop, the angle at which the pair of lever members cross each other is changed.

For example, there has been disclosed a keyswitch having a structure in which one of the lever members (the lever member whose top end rotatably engages the back surface of a keytop) and the other lever member (the lever member whose top end slidably engages the back surface of the key top) are linked at a portion where they cross each other so as to be formed into an integral structure, and the integrally formed pair of lever members guide the upward and downward movement of the keytop.

This type of keyswitch is turned on in the following manner. When an operator pushes the keytop, the pair of lever members are tilted and pushed downward. When the keytop has moved downward by a predetermined amount, an elastic member, such as a click rubber, is pushed by the keytop and deformed, after which a switch element of, for example, a membrane switch, is pushed by the elastic member to thereby turn on the keyswitch.

When the pushing operational force on the keytop is removed, the deformed elastic member is restored to its original shape due to its own resilient force, thereby bringing the membrane switch into an OFF state, and simultaneously pushing the keytop up to its initial height while causing the tilted pair of lever members to stand upright.

Accordingly, as compared to a conventional keyswitch whose key stem is slid along a guide wall, the structure in which a keytop is supported by a pair of lever members so as to be movable up and down achieves an ease of operation and a reduction in the height of the keyswitch.

In such a keyswitch, the membrane switch is placed on a metal plate, and portions of the metal plate are cut upward to form engaging portions. Bottom ends of the pair of combined lever members engage their corresponding engaging portions for assembly, whereby the top ends of the pair of combined lever members are movable upward and downward.

However, the keytop used in this type of conventional keyswitch is formed thin in order to make the keyswitch thin. In addition, a rotation engaging section and a slide engaging section are integrally formed at the back surface of the thin keytop in order to rotatably and slidably engage the top ends of the pair of lever members.

The shapes of the rotation engaging section and the slide engaging section are complicated. Thus, the shape of the keytop is likewise complicated. Therefore, the structure of a molding die used to form the keytop (by molding) becomes complicated, thereby resulting in an increase in the cost of the keytop.

In addition, since the rotation engaging section and the slide engaging section of the keytop are formed at the back surface of the keytop by molding, the assembly operation of engaging the top ends of the pair of lever members with the rotation engaging section and the slide engaging section of the keytop, respectively, becomes complicated, thereby making it difficult to automate the assembly operation.

This type of conventional keyswitch is assembled by engaging the bottom ends of the pair of combined lever members with the corresponding engaging portions formed by cutting up portions of the metal plate. However, since the bottom ends of the pair of lever members are mounted to the engaging portions after the membrane switch is placed on the metal plate, the sheet-shaped membrane switch becomes wavy or the like, thereby making it difficult to perform the assembly operation of engaging the pair of lever members with the engaging portions of the metal plate.

### SUMMARY OF THE INVENTION

Accordingly, in view of the first two problems, it is an object of the present invention to provide a keyswitch that can be reduced in cost by forming a plate-shaped actuator having a rotation connecting section and a slide connecting section with which top ends of a pair of lever members engage. The actuator is formed separately from the keytop, and is mounted by press-fitting it to the keytop.

In view of the third problem, it is an object of the present invention to provide a keyswitch which can be easily assembled, and whose assembly operation is easily automated by placing a lever mounting plate on the membrane switch, which is provided separately from the metal plate, and with which bottom ends of a pair of lever members engage. In addition, it is an object of the present invention to provide a method of assembling the keyswitch.

To these ends, according to a first aspect of the present invention, there is provided a keyswitch comprising a pair of lever members which are rotatably linked at a portion where the lever members cross each other, a keytop supported by the pair of lever members so as to be upwardly and downwardly movable, an elastic member for elastically biasing the keytop upwardly, and a switch element which is subject to a switching operation with the upward and downward movement of the keytop. An actuator, with which the top ends of the pair of lever members are engageable, is disposed in the keytop. In addition, the keytop is held by the actuator. Further, the elastic member directly elastically biases the keytop. Still further, with the upward and downward movement of the keytop, the pair of lever members are upwardly and downwardly movable through the actuator.

In a first form of the first aspect, a prismatic protrusion is formed at a portion of the keytop that is stopped by the actuator, and side surfaces formed at a periphery of the prismatic protrusion are formed flat. In addition, the actuator has a dislodging preventing stopper portion capable of preventing the actuator from becoming dislodged by being press-contacted to the side surfaces at the periphery of the protrusion, a plurality of press-contact portions supported in a cantilever manner being provided at the dislodging-preventing stopper portion, and the press-contact portions being press-contacted to the corresponding side surfaces at the protrusion so that the keytop will be held by the actuator.

In a second form based upon the first form, the press-contact portions are formed so as to be supported in the cantilever manner by causing the press-contact portions to protrude inwardly from an inner peripheral wall defining a hole which passes through the actuator, and ends of the press-contact portions are such as to press-contact the corresponding side surfaces at the protrusion.

In a third form based upon the second form, the actuator is formed of a metallic plate, and the press-contact portions are formed so as to protrude inwardly from four directions of the inner peripheral wall defining the hole. In addition, the keytop is formed of a resin material, and the prismatic protrusion has the shape of a square pole. Further, the press-contact portions are press-fitted to the corresponding four side surfaces at the periphery of the square-pole-shaped protrusion.

In a fourth form based upon the third form, the square-pole-shaped protrusion has a cross-shaped presser portion formed so as to protrude in a diagonal direction from a corner where the side surfaces intersect each other, the length of the presser portion in the diagonal direction being greater than the size of a top portion of the elastic member, and the presser portion being brought into contact with the top portion of the elastic member in order for the elastic member to elastically bias the keytop.

According to a second aspect of the present invention, there is provided a keyswitch comprising a pair of lever members which are rotatably linked at a portion where the lever members cross each other, a keytop supported by the pair of lever members so as to be upwardly and downwardly movable, an elastic member for elastically biasing the keytop upwardly, and a switch element which is subject to a switching operation with the upward and downward movement of the keytop. A lever mounting plate, with which bottom ends of the pair of lever members are engageable, is mounted to a holding plate and is placed on the switch element. In addition, the lever mounting plate includes a rotation engaging section and a slide engaging section. The rotation engaging section has an open portion and allows the bottom end of one of the lever members to rotatably engage therewith. The slide engaging section has an open portion and allows the bottom end of the other lever member to slidably engage therewith. The open portion of the rotation engaging section and the open portion of the slide engaging section open in the same direction.

In one form of the second aspect of the present invention, the lever mounting plate is a metallic plate. The lever mounting plate has a pair of first cut-up portions at one side thereof. In addition, the slide engaging section which has the open portion is formed into a U shape at the first cut-up portions, and two opposing sides of the U-shaped slide engaging section are formed parallel to each other.

In another form of the second aspect of the present invention, a pair of second cut-up portions are formed at the other side of the lever mounting plate so as to be separated from the first cut-up portions, the rotation engaging section being formed into a U shape at the second cut-up portions, and a protrusion being formed near the open portion at either one of or both opposing sides of the rotation engaging section, the protrusion being provided to reduce the width of the open portion.

According to a third aspect of the present invention, there is provided a method of assembling a keyswitch, wherein a pair of lever members which are rotatably linked at a portion where the lever members cross each other are provided; wherein top ends of the pair of lever members are made upwardly and downwardly movable through an actuator with the upward and downward movement of a keytop, which is elastically biased by an elastic member; wherein bottom ends of the pair of lever members are made engageable with a lever mounting plate; wherein the bottom ends of the pair of lever members are positioned on the lever mounting member, the pair of lever members are moved from one side to the other, and the bottom ends of the pair of lever members are made to engage the lever mounting plate in order to assemble the keyswitch.

In a form of the third aspect of the present invention, by moving the pair of lever members from one side to the other, the bottom end of one of the lever members engages a rotation engaging section of the lever mounting plate by a snap-in operation so that the one of the lever members is rotatable thereat, and the bottom end of the other lever member is slid to engage a slide engaging section of the lever mounting plate so that the other lever member is slidable thereat.

### BRIEF DESCRIPTION OF THE DRAWINGS

FIG. 1 is a sectional view of the main portion of a keyswitch in accordance with the present invention.

FIG. 2 is a plan view of FIG. 1.

FIG. 3 is a front view of a keytop used in the present invention.

FIG. 4 is a bottom view of FIG. 3.

FIG. 5 is a sectional view of the main portion of FIG. 4.

FIG. 6 is a plan view of an actuator used in the present invention.

FIG. 7 is a side view of FIG. 6.

FIG. 8 is an enlarged sectional view of the main portion of FIG. 6.

FIG. 9 is a plan view of an inner lever member used in the present invention.

FIG. 10 is a side view of FIG. 9.

FIG. 11 is a plan view of an outer lever member used in the present invention.

FIG. 12 is a side view of FIG. 11.

FIG. 13 is a plan view of an integrally formed pair of lever members used in the present invention.

FIG. 14 is a side view of FIG. 13.

FIG. 15 is a side view of the top portion of a lever mounting plate used in the present invention.

FIG. 16 is a left side view of FIG. 15.

FIG. 17 is a plan view of FIG. 15.

FIG. 18 is a front view of FIG. 17.

FIG. 19 is a plan view of a holding plate used in the present invention.

FIG. 20 is an enlarged view of the main portion of FIG. 19.

FIG. 21 illustrates an integrally formed holding plate and lever mounting plate used in the present invention.

FIG. 22 is a sectional view showing elastic members mounted to a membrane switch, used in the present invention.

FIG. 23 illustrates a step in the method of assembling the keyswitch in accordance with the present invention.

FIG. 24 illustrates a step in the method of assembling the keyswitch in accordance with the present invention.

FIG. 25 illustrates a step in the method of assembling the keyswitch in accordance with the present invention.

### DESCRIPTION OF THE PREFERRED EMBODIMENT

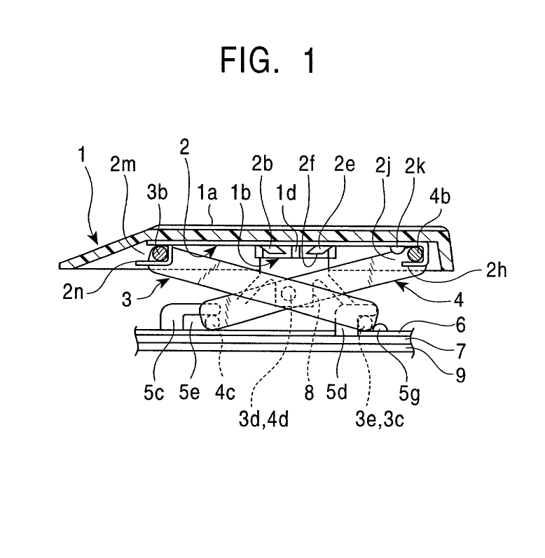

As shown in FIG. 1, a keyswitch of the present invention has a keytop 1 at the topmost portion thereof. The keytop 1 is described with reference to FIGS. 3 to 5.

The keytop 1 is, for example, molded out of a resin material so as to have a substantially rectangular external shape. The top surface of the keytop 1 is formed as an operating surface 1a having a circular arc shape. A square-pole-shaped protrusion 1b protrudes from substantially the center portion of the back surface of the keytop 1. The keytop 1 has four side surfaces 1c that surround the square-pole-shaped protrusion 1b. The side surfaces 1c are formed flat.

A cross-shaped presser portion 1d is formed so as to protrude outward in a diagonal direction from a corner of the protrusion 1b where the side surfaces 1c intersect. A size A of the presser portion 1d in the diagonal direction is longer than diameters C of top portions 8c of elastic members 8 (described later). The elastic members 8 directly elastically bias the presser portion 1d in order to allow the keytop 1 to move up and down.

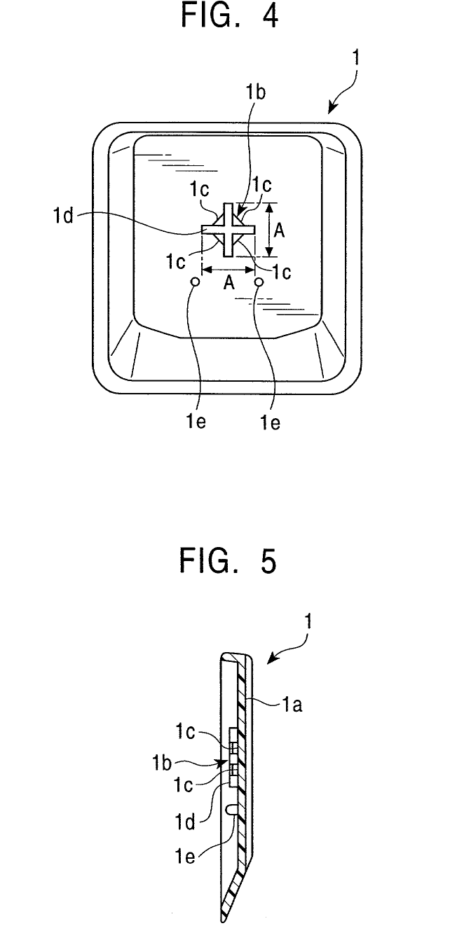

A pair of positioning protrusions 1e are formed near the bottom portion of the protrusion 1b shown in FIG. 4.

An actuator 2, which stops the protrusion 1b of the keytop 1, is formed of a metallic plate, such as a stainless steel plate. When the keytop 1 is stopped by the actuator 2, a flat mounting surface 2a is such as to be mounted in close contact with the bottom surface of the keytop 1.

A dislodging-preventing stopper portion 2b, to which the protrusion 1b of the keytop 1 can be press-fitted, is formed at substantially the center portion of the mounting surface 2a. At the dislodging-preventing stopper portion 2b, four press-contact portions 2e supported in a cantilever manner are disposed so as to protrude inwardly from the four directions of an inner peripheral wall 2d defining a through hole 2c.

As shown in the enlarged view of FIG. 8, the press-contact portions 2e, supported in a cantilever manner, are bent slightly downwards at end portions 2f. When the protrusion 1b of the keytop 1 is press-fitted to the dislodging-preventing stopper portion 2b from the direction of arrow B, the end portions 2f of the press-contact portions 2e are press-contacted to the four corresponding side surfaces 1c surrounding the protrusion 1b in order to stop the keytop 1 so that it does not get dislodged from the actuator 2.

Since the actuator 2 is formed of a metallic plate and the keytop 1 is formed of a resin material, the end portions 2f of the press-contact portions 2e are such as to be driven into the side surfaces 1c, so that the force required to pull the keytop 1 out of the actuator 2 can be made large, thereby making it possible to firmly stop dislodgement of the keytop 1 from the actuator 2.

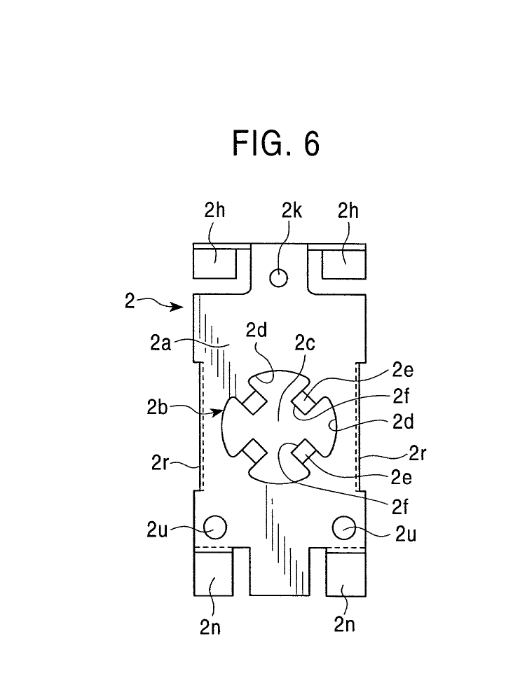

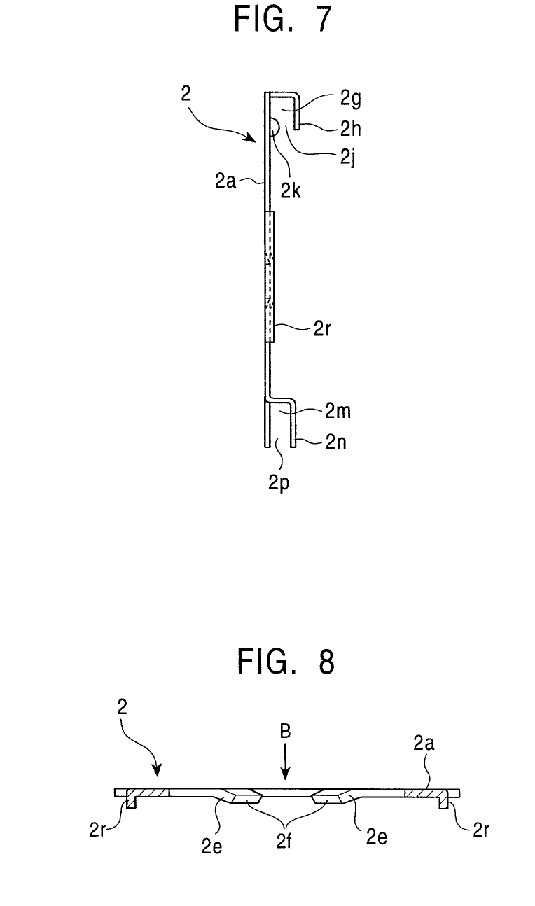

A rotation engaging section 2g, whose side is bent into a substantially U shape, is formed at one end portion (that is, the top end portion side) of the mounting surface 2a (shown in FIG. 7) in the longitudinal direction thereof. As shown in FIG. 6, engaging portions 2h and 2h are formed at the rotation engaging section 2g. The engaging portions 2h and 2h are spaced away portions parallel to the mounting surface 2a that extend from the upwardly extending portion of the mounting surface 2a (as shown in FIG. 6) towards the central portion thereof. As shown in FIG. 7, the engaging portions 2h and 2h are formed by a cutting and bending operation in order to form the rotation engaging section 2g.

As shown in FIG. 7, the side surface of the rotation engaging section 2g is formed into a U shape by opposing a side of the mounting surface 2a with sides of the engaging portions 2h. The rotation engaging section 2g has open portions 2j which face downward in FIG. 7. A protrusion 2k, which decreases the widths of the open portions 2j, is formed on the mounting surface 2a near the open portions 2j.

By a snap-in operation of a top end rotating shaft 4b, or the top end of an outer lever 4 (described later), with respect to the rotation engaging section 2g inward from the open portions 2j (whose widths are made smaller), the top end rotating shaft 4b is such as to be rotatable inside the rotation engaging section 2g.

The protrusion 2k, which decreases the widths of the open portions 2j, may be formed at the engaging portions 2h and 2h or at the mounting surface 2a and the engaging portions 2h. These protrusions are not shown.

In other words, the protrusion 2k may be formed at the mounting surface 2a or the engaging portions 2h (which are opposing sides defining the open portions 2j), or both, near the open portions 2j.

A slide engaging section 2m having an open portion 2p whose side has a substantially U shape is formed at the other end portion (that is, the bottom end portion side shown in FIG. 7) of the mounting surface 2a in the longitudinal direction thereof.

As shown in FIG. 6, tongue-shaped engaging portions 2n and 2n are formed at the slide engaging section 2m. These engaging portions 2n and 2n are formed at the left and right sides (in FIG. 6) of an illustrated downwardly extending portion of the mounting surface 2a near the central portion thereof. The engaging portions 2n and 2n have their side surfaces bent into U-shapes.

The slide engaging section 2m is formed by positioning the mounting surface 2a and the engaging portions 2n (which are opposing sides defining open portions 2p) parallel to each other. A top end slide shaft 3b, or the top end of an inner lever member 3, engages the slide engaging section 2m so as to be slidable thereat.

As shown in FIG. 7, the open portions 2j of the rotation engaging section 2g and the open portions 2p of the slide engaging section 2m open downward in the same direction.

As shown in FIG. 6, positioning holes 2u and 2u are formed as through holes in portions of the mounting surface 2a near the top portions of the engaging portions 2n and 2n that form the slide engaging section 2m. The positioning protrusions 1e of the keytop 1 can be fitted to the corresponding positioning holes 2u and 2u.

As shown in FIG. 6, a pair of reinforcing portions 2r are formed on the left and right sides of the portion of the mounting surface 2a where the dislodging-preventing stopper portion 2b is formed.

When the lever member 3 and the lever member 4 (described later) are made to engage the slide engaging section 2m and the rotation engaging section 2g, respectively, the reinforcing portions 2r prevent the flat mounting surface 2a from warping even when the actuator 2 moves up and down.

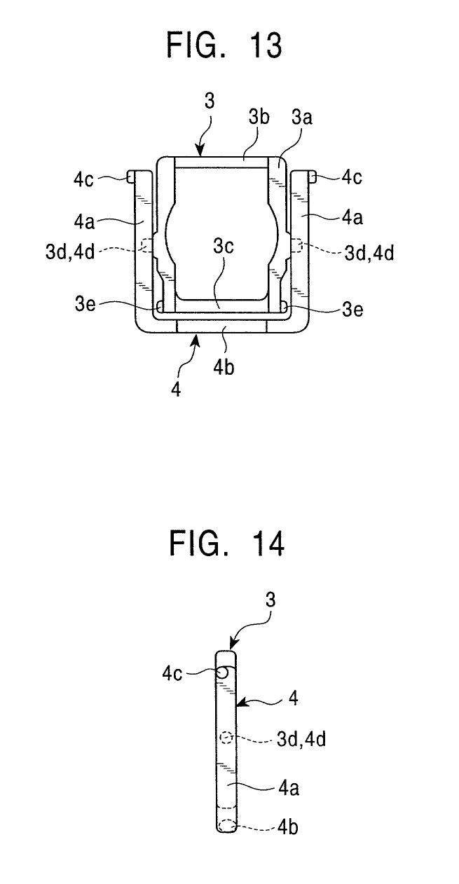

The pair of lever members, one of which engages the rotation engaging section 2g and the other of which engages the slide engaging section 2m, comprises the inner lever member 3 and the outer lever member 4. The inner lever member 3 and the outer lever member 4 are molded out of resin materials having different contraction rates, and are formed into an integral structure as shown in FIG. 13.

In other words, the inner lever member 3 and the outer lever member 4 are formed into an integral structure by assembling them using a mold and using different materials.

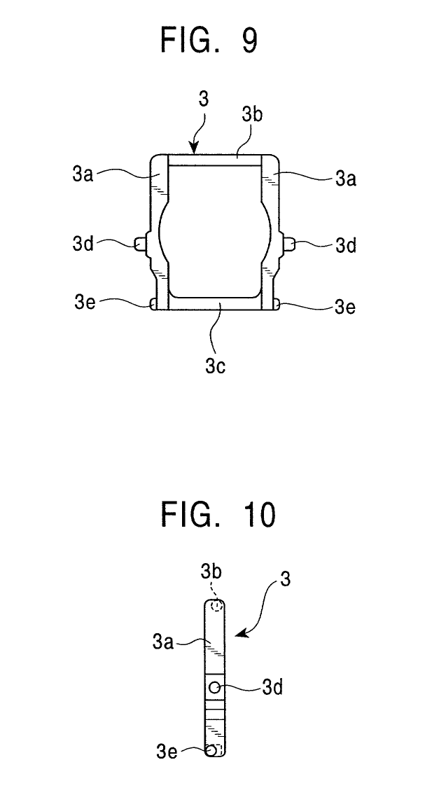

As shown in FIGS. 9 and 10, the inner lever member 3 has a pair of tilting legs 3a that extend vertically upward and downward. The tilting legs 3a and 3a are connected to the top end slide shaft 3b, formed at the upper part in FIGS. 9 and 10, and a bottom end rotation shaft 3c, formed at the lower part in these figures, so that the inner lever member 3 has a substantially rectangular external shape.

Outwardly protruding connecting pins 3d are formed at the middle of the corresponding tilting legs 3a (as viewed in the vertical direction in FIGS. 9 and 10), at the sides of the inner lever member 3. Protruding bottom end rotating pins 3e are formed outwardly from the corresponding tilting legs 3a on a line coincident with the rotating pin 3c.

As shown in FIG. 1, the top end slide shaft 3b (or the top end) of the inner lever member 3 slidably engages the slide engaging section 2m of the actuator 2, and the bottom end rotating shaft 3c (that is, the bottom end) of the inner lever member 3 and the bottom end rotating pins 3e rotatably engage and are mounted to a lever mounting plate 5 (described later).

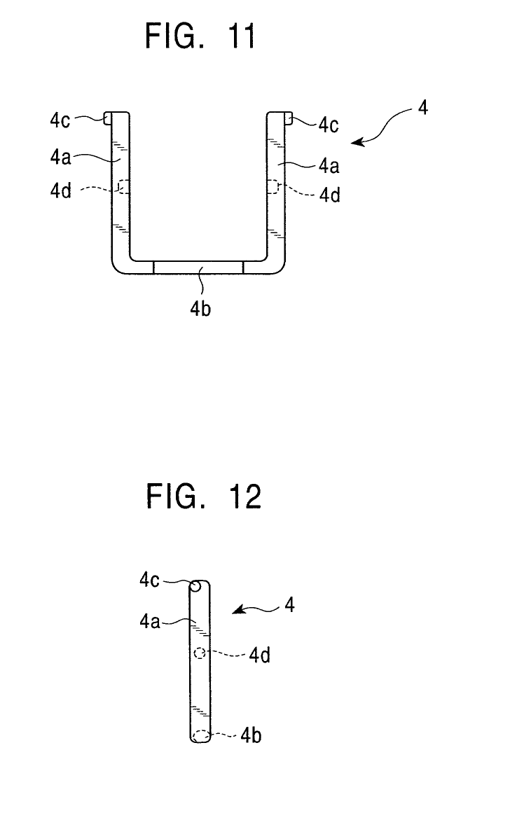

As shown in FIGS. 11 and 12, the outer lever member 4 has a pair of tilting legs 4a that extend vertically upward and downward. The tilting legs 4a and 4a are connected to the top end rotating shaft 4b (formed at the lower part in FIGS. 11 and 12), so that the outer lever member 4 has a U-shaped external form.

Protruding bottom end slide pins 4c and 4c are formed at the outer top portions of the sides of the corresponding tilting legs 4a shown in FIG. 11. Pin insertion holes 4d are formed with predetermined depths at the middle portions of the corresponding tilting legs 4a (as viewed in the vertical direction in FIGS. 11 and 12) so as to extend from the inside to the outside. The connecting pins 3d of the inner lever member 3 can be rotatably fitted to the corresponding pin insertion holes 4d.

As shown in FIG. 1, the top end rotating shaft 4b, or the top end of the outer lever member 4, rotatably engages the rotation engaging section 2g of the actuator 2, and bottom end slide pins 4c, or the bottom end of the outer lever member 4, slidably engages and is mounted to the lever mounting plate 5 (described later).

When two-color molding is carried out, as shown in FIGS. 13 and 14, the pair of lever members 3 and 4 are formed into an integral structure by connecting them so that that they can rotate as a result of carrying out a molding operation while the connecting pins 3d are fitted to the corresponding pin insertion holes 4d, serving as crossing portions.

In accordance with changes in the tilting angles of the tilting legs 3a and 4a, the top end slide shaft 3b of the lever member 3 and the top end rotating shaft 4b of the lever member 4 are such that their heights change.

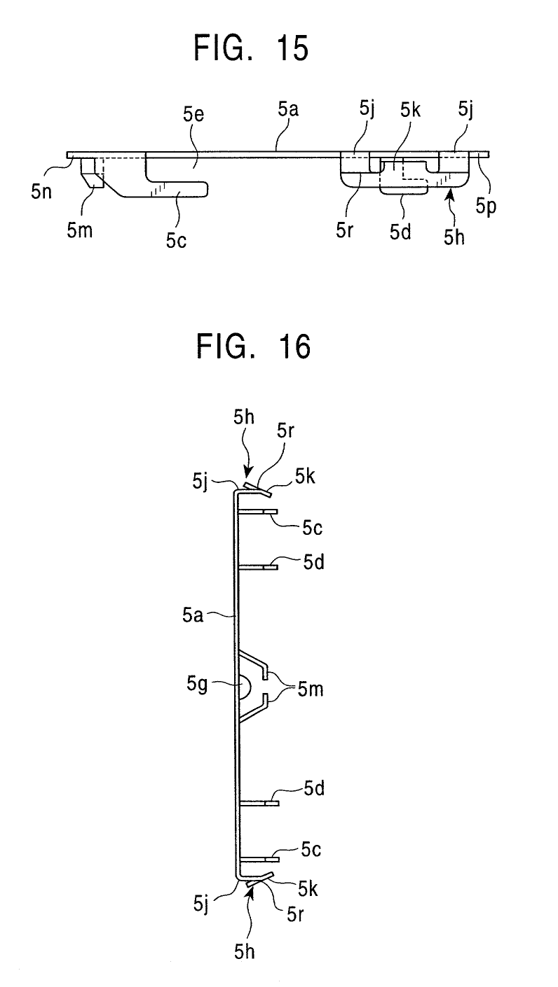

With reference to FIGS. 15 to 18, the lever mounting plate 5 for rotatably engaging the bottom end rotating shaft 3c and the bottom end rotating pins 3e, or the bottom end of the inner lever member 3, and for slidably engaging the bottom end slide pins 4c, or the bottom end of the outer lever member 4, is described.

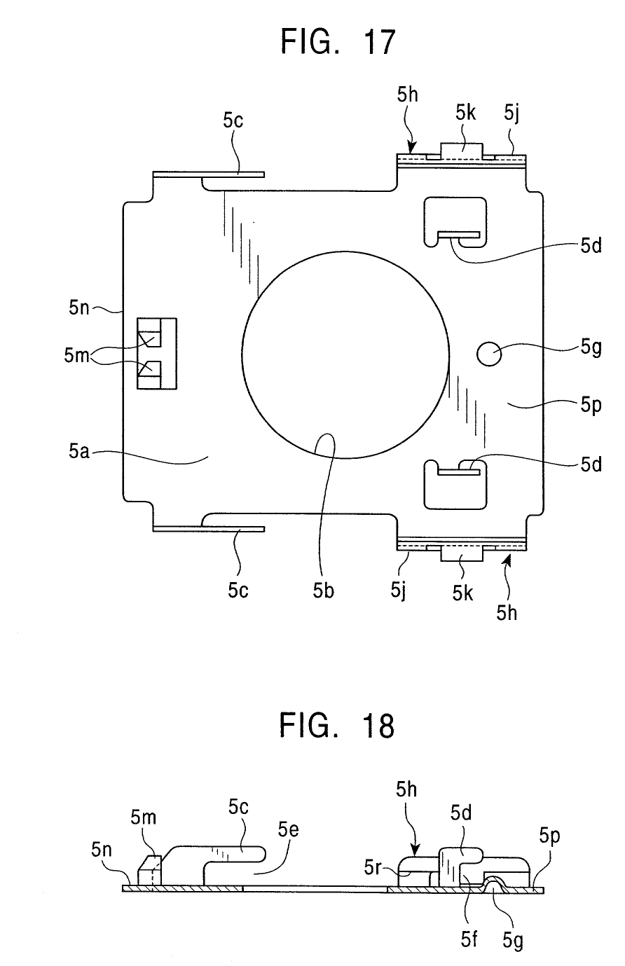

The lever mounting plate 5 is formed of a metallic plate, such as a stainless steel plate, and, as shown in FIG. 17, the lever mounting plate 5 is formed with a substantially rectangular external shape by, for example, a pressing operation. The lever mounting plate 5 has a substantially rectangular base 5a, with a circular through hole 5b for inserting the elastic members 8 (described later) being formed in substantially the central portion of the base 5a.

A pair of first cut-up portions 5c are formed at the top and bottom sides of the left end portion of the base 5a shown in FIG. 17. A pair of second cut-up portions 5d are formed above and below the through hole 5b, at the right side portion of the base 5a.

As shown in FIG. 18, the first cut-up portions 5c and the second cut-up portions 5d have substantially L-shaped sides. U-shaped slide engaging sections 5e are formed at the first cut-up portions 5c, with the bottom end slide pins 4c, or the bottom end of the outer lever member 4, being engageable with them.

U-shaped rotation engaging sections 5f, that are shallower than the slide engaging sections 5e, are formed at the second cut-up portions 5d. The bottom end rotating pins 3e, or the bottom end of the inner lever member 3, can engage with them.

A protrusion 5g, that protrudes upward from the base 5a, is formed near the open portions of the rotation engaging sections 5f (shown in FIG. 18) at substantially the center portion of the base 5a between the pair of second cut-up portions 5d and 5d (shown in FIG. 17). The protrusion 5g narrows the width of the open portions at the sides of the rotation engaging sections 5f.

Therefore, when the bottom end rotating pins 3e, or the bottom end of the inner lever member 3, are pushed into and engage the rotation engaging sections 5f, the bottom end rotating shaft 3c is subjected to a snap-in operation by the protrusion 5g, so that the bottom end rotating pins 3e engage within the rotation engaging sections 5f so that they can rotate.

The open portions of the slide engaging sections 5e and the rotation engaging sections 5f open in the same direction, that is, towards the right in FIG. 18.

Therefore, by inserting the bottom ends of the pair of lever members into the slide engaging sections 5e and the rotation engaging sections 5f from the same direction, the pair of lever members 3 and 4 can be mounted to the lever mounting plate 5, thereby making it easy to automate the assembly operation.

The protrusion 5g is formed at substantially the center portion interposed between the pair of second cut-up portions 5d and 5d shown in FIG. 17. By the protrusion 5g, the entrances of the rotation engaging sections 5f, formed at the second cut-up portions 5d and 5d shown in FIG. 18, are made narrow.

Therefore, when the bottom-end rotating pins 3e, or the bottom end of the inner lever member 3, are pushed into the rotation engaging sections 5f, the bottom-end rotating shaft 3c is subjected to a snap-in operation by the protrusion 5g, so that the bottom-end rotating pins 3e rotatably engage inside the rotation engaging sections 5f.

As shown in FIG. 17, stopper portions 5h for temporarily attaching the lever mounting plate 5 to a holding plate 6 (described later) are formed by cutting upwards both top and bottom side portions where the corresponding second cut-up portions 5d are formed.

As shown in FIG. 16, side walls 5j are formed at their corresponding stopper portions 5h by cutting up at right angles both top and bottom side portions of the base 5a.

Hooks 5k are formed by cutting off left and right portions near the central portions of their corresponding side walls 5j (shown in FIG. 15) from the base 5a. The hooks 5k and the corresponding side walls 5j are formed so that upper right sides (shown in FIG. 16) thereof are bent inwardly at predetermined angles from corresponding bending lines 5r.

Third cut-up portions 5m are formed at the left end center portion of the base 5a (shown in FIG. 17). A left end 5n is formed by the extension of a portion of the base 5a towards the left (in FIG. 17) of the third cut-up portions 5m.

A right end portion 5p is formed by the extension of a portion of the base 5a disposed between the upper and lower stopper portions 5h towards the right.

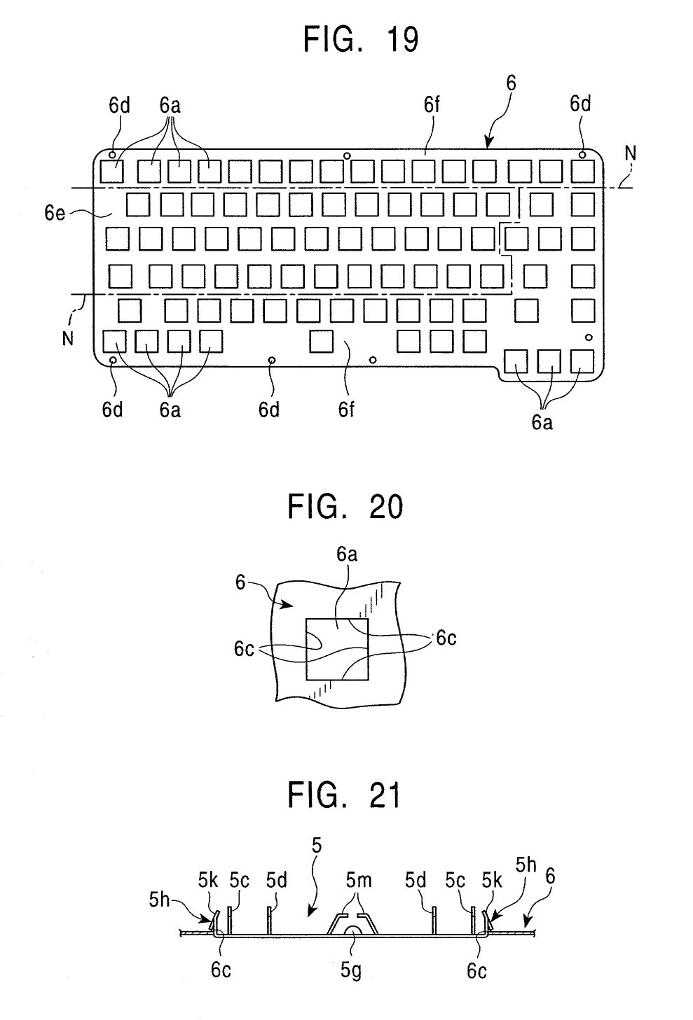

The holding plate 6, for snapping in the stopper portions 5h of the lever mounting plate 5, is a plate, such as a metallic plate formed of, for example, stainless steel, for arranging keys thereon. As shown in FIG. 19, in accordance with the arrangement of a plurality of keys of a keyboard, a plurality of mounting holes 6a are punched out by, for example, a pressing operation.

As shown in FIG. 20, each mounting hole 6a is enclosed by a pair of corresponding opposing first side walls 6b and a pair of corresponding opposing second side walls 6c, and is formed into a rectangular shape. A plurality of small circular positioning holes 6d are punched out at portions of the holding plate 6 towards the outer periphery thereof.

For the holding plate 6, one key arranging plate is used. However, the plate used may be such as to be divided into a plurality of key arranging plates, that is, a common plate 6e and a changing plate 6f, as a result of dividing one plate along division lines N (shown by the alternate long and short dash lines) shown in FIG. 19.

The lever mounting plate 5 is snapped in the mounting holes 6a of the holding plate 6 and is temporarily held thereat in the following way. As shown in FIG. 21, the lever mounting plate 5 is positioned at the bottom portion of the holding plate 6. When the lever mounting plate 5 is pushed into the mounting holes 6a, the hooks 5k are pushed into the mounting holes 6a while being elastically deformed along the second side walls 6c. This causes the lever mounting plate 5 to be snapped in the mounting holes 6a and, thus, to be temporarily held.

The lever mounting plate 5, that has been temporarily held in the mounting holes 6a as a result of snapping them in the mounting holes 6a, is positioned inside the mounting holes 6a as a result of bringing the right end surfaces of the stopper portions 5h (shown in FIG. 17) and the left end surfaces of the third cut-up portions 5m into contact with the first side walls 6b of the corresponding mounting holes 6a.

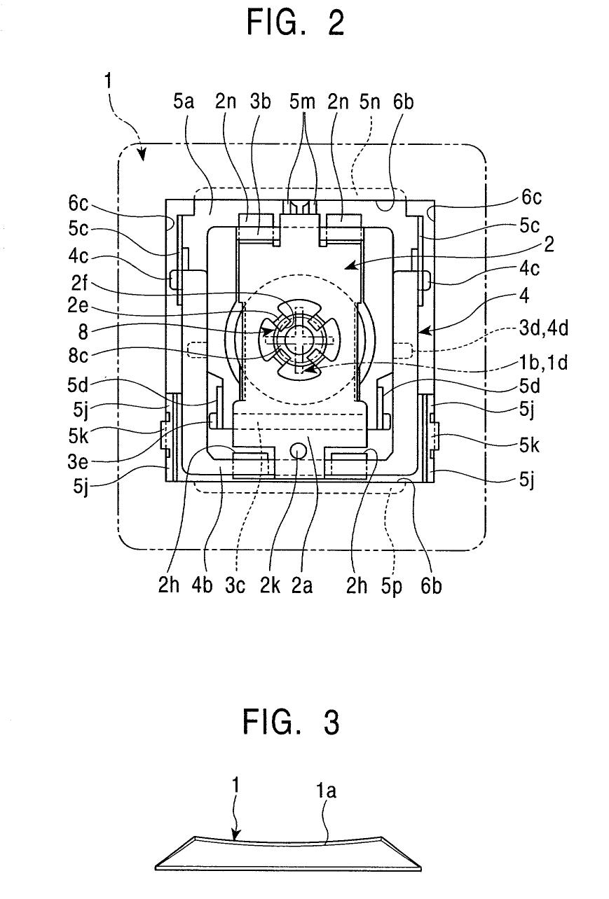

As shown in FIG. 2, the lever mounting plate 5, that has been temporarily held by the holding plate 6 as a result of a snap-in operation of the stopper portions 5h with respect to the holding plate 6, is prevented from getting dislodged as a result of bringing the left end 5n and the right end 5p of the base 5a into contact with the back surface of the holding plate 6.

As shown in FIG. 1, the membrane switch 7 having switch elements formed thereon is disposed at the bottom portion of the holding plate 6 that temporarily holds the lever mounting plate 5.

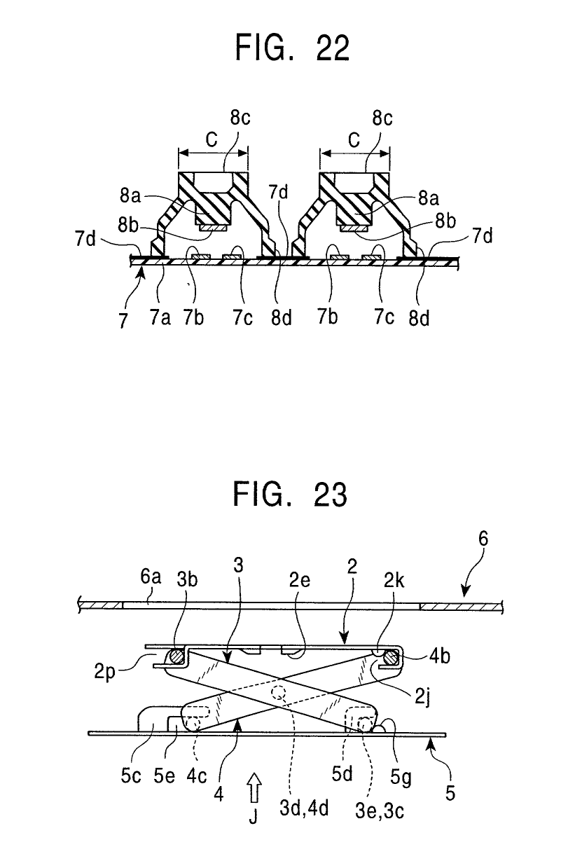

As shown in FIG. 22, the membrane switch 7 is formed by forming the first electrodes 7b and the second electrodes 7c opposing them, which are switch elements, on an insulating film sheet 7a by, for example, printing.

When the first electrodes 7b and the second electrodes 7c contact electrically conducting portions 8b of the elastic members 8 (described later), electrical conduction occurs therebetween, thereby turning on the membrane switch 7.

With the first electrodes 7b and the second electrodes 7c being exposed, resist films 7d having predetermined thicknesses are formed near the first electrodes 7b and the second electrodes 7c. The top surface of a wiring pattern (not shown) led out from the first electrodes 7b and the second electrodes 7c are covered by the resist films 7d in order to be insulated.

An air hole (not shown) is formed by punching out a portion of the film sheet 7a near the first electrodes 7b or the second electrodes 7c.

The elastic members 8, having dome-shaped inside portions, are disposed above the first electrodes 7b and the second electrodes 7c. The elastic members 8 have corresponding presser protrusions 8a that protrude downward from corresponding inside dome-shaped ceilings. The electrically conducting portions 8b, which are electrically conductive films, are formed at the bottom ends of the corresponding presser protrusions 8a by printing or the like.

The elastic members 8 have circular top portions 8c which protrude from the corresponding dome-shaped ceilings and which have diameters C. Skirts 8d are formed at the dome-shaped bottom portions of the corresponding elastic members 8. The skirts 8d are affixed to the corresponding resist films 7d of the membrane switch 7 with, for example, an adhesive in order to form the membrane switch 7 and the elastic members 8 into an integral structure.

A metal plate 9, which is a metal plate formed of, for example, aluminum, is formed at the bottom portion of the membrane switch 7 shown in FIG. 1. The metal plate 9 has an air hole (not shown) which is formed by punching out a portion thereof in correspondence with the location of the air hole (not shown) in the membrane switch 7, and which is of the same size as the air hole (not shown) formed in the membrane switch 7. It is formed so that, when the elastic members 8 are pushed and deformed, the air inside the elastic members 8 can escape to the outside.

The metal plate 9 has a plurality of positioning protrusions (not shown). These positioning protrusions are fitted to the positioning holes 6d of the holding plate 6 and a positioning hole (not shown) of the membrane switch 7 in order to position the holding plate 6 and the membrane switch 7 at the metal plate 9.

A description of the assembly the keyswitch of the present invention having such structure will be given with reference to FIGS. 23 to 25. As shown in FIG. 25, in the assembly of a lever-mounting-plate primary-half-finished product in which the bottom ends of the lever members 3 and 4 that are integrally formed by molding different types of materials are mounted to the lever mounting plate 5, the bottom-end rotating pins 3e, or the bottom end of the inner lever member 3, are positioned near the open portions of the rotation engaging portions 5f at the corresponding second cut-up portions 5d, and the bottom-end slide pins 4c, or the bottom end of the outer lever member 4, are positioned near the open portions of the slide engaging sections 5e at the first cut-up portions 5c.

When the pair of lever members 3 and 4 are moved from right to left, from one side to the other in FIG. 25, the bottom-end slide pins 4c of the outer lever member 4 are moved in the direction of arrow D, and engage the slide engaging sections 5e formed at the corresponding first cutup portions 5c.

The bottom-end rotating pins 3e of the inner lever member 3 are moved in the direction of arrow E, and are inserted into the rotation engaging sections 5f. This causes the bottom-end rotating shaft 3c to be bent by the protrusion 5g and to be moved towards the left in FIG. 25, so that the bottom-end rotating pins 3e are snapped in the rotation engaging sections 5f and are prevented from becoming dislodged.

The bottom-end rotating pins 3e are rotable inside the corresponding rotation engaging sections 5f, and the bottom-end slide pins 4c are slidable inside the corresponding slide engaging sections 5e.

At this time, the top-end slide shaft 3d, or the top end of the lever member 3, and the top-end rotating shaft 4b, or the top end of the lever member 4, are capable of moving up and down.

In the assembly of the lever-mounting-plate primary-half-finished-product in which the pair of lever members 3 and 4 are mounted to the lever mounting plate 5, the slide engaging sections 5e and the rotation engaging sections 5f of the lever mounting plate 5 are open in the same direction, so that the integrally formed pair of lever members 3 and 4 can be mounted to the lever mounting plate 5 for assembly by only moving them from one side to the other, thereby facilitating the automation of the assembly.

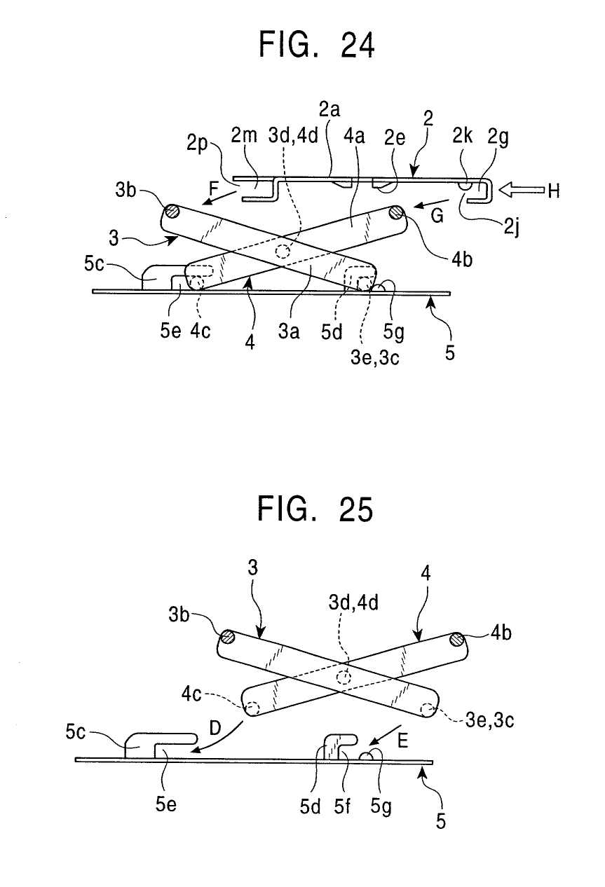

As shown in FIG. 24, in the assembly of a lever-mounting-plate secondary-half-finished-product in which the actuator 2 is mounted to the pair of lever members 3 and 4 that have been mounted to the lever mounting plate 5, the slide shaft 3b, or the top end of the lever member 3 (of the lever-mounting-plate primary-half-finished product), and the top-end rotating shaft 4b, or the top end of the lever member 4 (of the lever-mounting-plate primary-half-finished product), are moved upward in such a manner as to cross each other in the form of the shape of the letter X.

With the pair of lever members 3 and 4 crossing each other so as to form the shape of the letter X, the open portions 2j at the rotation engaging section 2g of the actuator 2 are positioned near the top-end rotating shaft 4b of the outer lever member 4, and the open portions 2p at the slide engaging section 2m of the actuator 2 are positioned near the top-end slide shaft 3b of the inner lever member 3.

When weight is exerted in the direction of arrow H parallel to the mounting surface 2a from the rotation engaging section 2g of the actuator 2, the actuator 2 moves from right to left (from one side to the other in FIG. 24), causing the slide engaging section 2m to move in the direction of arrow F and the top-end slide shaft 3b of the inner lever member 3 to be slidably inserted into the slide engaging section 2m.

The rotation engaging section 2g move in the direction of arrow G, causing the top-end rotating shaft 4b of the outer lever member 4 to be rotatably snapped in the rotation engaging section 2g.

In the lever-mounting-plate secondary-half-finished product, the open portions of the rotation engaging section 2g and those of the slide engaging section 2m are open in the same direction, so that the actuator 2 can be mounted to the pair of lever members 3 and 4 by only moving the actuator 2 from one side to the other, thereby facilitating the automation of the assembly.

Next, as shown in FIG. 23, in the assembly of a holding-plate primary-half-finished product in which the lever-mounting-plate secondary-half-finished product having the actuator 2 mounted therein is snapped in and temporarily held in the mounting holes 6a of the holding plate 6, the lever-mounting-plate secondary-half-finished product is positioned below the mounting holes 6a of the holding plate 6. Then, the lever mounting plate 5 is raised upward in the direction of arrow J, and is pushed into the mounting holes 6a.

When this is done, the stopper portions 5h of the lever mounting plate 5 are pushed into the inside of and snapped in the mounting holes 6a, and the left end 5n and the right end 5p come into contact with and are stopped by the back surface of the holding plate 6 so as not to get dislodged. This causes the lever-mounting-plate secondary-half-finished product to be temporarily held by the holding plate 6, thereby assembling the holding-plate primary-half-finished product.

In the assembly of the holding-plate primary-half-finished product, a plurality of the lever-mounting-plate secondary-half-finished product can be arranged in a row at the same locations as the plurality of mounting holes 6a of the holding plate 6 in order for the lever mounting plate 5 to be snapped in the plurality of mounting holes 6a all at once for assembly, thereby facilitating the automation of the assembly.

In the holding-plate primary-half-finished product assembled by carrying out this procedure, even when a twisting force in the direction of rotation is applied to the lever mounting plate 5 that is temporarily held by the holding plate 6, the illustrated bottom ends of the stopper portions 5h of the lever mounting plate 5 contact the illustrated bottom first side walls 6b of the mounting holes 6a, and the third cut-up portions 5m contact the illustrated top first side walls 6b of the mounting holes 6a, so that twisting of the lever mounting plate 5 is restricted.

By providing a plurality of third cut-up portions 5m shown in FIG. 2 along the illustrated top first side walls 6b, the twisting of the lever mounting plate 5 can be more reliably restricted.

In the assembly of a holding-plate secondary-half-finished product in which the keytop 1 is mounted to the actuator 2 of the holding-plate primary-half-finished product, the protrusion 1b of the keytop 1 is positioned at the dislodging-preventing stopper portion 2b of the actuator 2 of the holding-plate primary-half-finished product, and the cross-shaped presser portion 1d is positioned between the press-contact portions 2e.

When the bottom surface side of the mounting surface 2a of the actuator 2 is placed on a jig (not shown), and the keytop 1 is pressed from above by, for example, the jig, the protrusion 1b is press-fitted to the dislodging-preventing stopper portion 2b.

At this time, as shown in FIG. 1, the ends 2f of the four press-contact sides 2e press-contact the four side surfaces 1c at the protrusion 1b in order for the keytop 1 to be mounted to the actuator 2 by holding it so that it does not get dislodged, whereby the holding-plate secondary-half-finished product is assembled.

In the assembly of the holding-plate secondary-half-finished product, a plurality of the keytops 1 can be positioned at corresponding dislodging-preventing stopper portions 2b of a plurality of actuators 2, and can be press-fitted at the same time by one press-fitting operation, so that the automation of the assembly is facilitated.

Next, the membrane switch 7, formed integrally with the elastic members 8, is placed on the metal plate 9 shown in FIG. 1, and the holding-plate half-finished product having the keytop 1 mounted therein is placed on the membrane switch 7.

This causes a plurality of elastic members 8 to be inserted into and positioned at a plurality of through holes 5b at the center portion of the lever mounting plate 5, causing the top portions 8c of the elastic members 8 to come into contact with the cross-shaped presser portion 1d of the keytop 1. The keytop 1 is elastically biased upward in FIG. 1, and the pair of lever members 3 and 4 move upward, so that they form the shape of the letter X shown in FIG. 1.

In the keyswitch of the present invention assembled by this procedure, when the keytop 1 shown in FIG. 1 is moved downward as a result of pushing it downward, the tilting legs 3a and 4a of the corresponding lever members 3 and 4 that cross each other so as to form the shape of the letter X are tilted, and are brought into substantially horizontal positions.

Then, the dome-shaped elastic members 8 are deformed and buckled as a result of being directly pushed by the presser portion 1d of the keytop 1. The buckling causes a tactile feel to be produced at the elastic members 8, and the first electrodes 7b and the second electrodes 7c to be brought into electrical conduction as a result of the electrically conductive portions 8b of the corresponding elastic members 8 coming into contact with the first electrodes 7b and the second electrodes 7c of the membrane switch 7.

The switch elements, that is, the first electrodes 7b and the second electrodes 7c, are turned on in order to perform a switching operation.

Here, since the elastic members 8 are directly in contact with the keytop 1 in order to be elastically biased, the tactile feel produced at the elastic members 8 is directly transmitted to the keytop 1, so that the user can operate the keytop 1 with a proper feel.

With the switch elements being switched on, when the pushing force on the keytop 1 is removed, the buckled elastic members 8 are restored to their original dome-shaped forms by their own elastic forces, causing the presser portion 1b of the keytop 1 to move upward as a result of being directly pushed upward by the elastic members 8.

Then, the tilting legs 3a and 4a of the corresponding levers 3 and 4 return to their initial state or the X-shaped crossed state, as shown in FIG. 1. When the elastic members 8 are restored to their original dome-shaped forms, the electrically conductive portions 8b which have been brought into electrical conduction with their corresponding first and second electrodes 7b and 7c as a result of being brought into contact with them move upward, thereby turning off the switch elements.

In the description of the embodiment of the present invention, the protrusion 1b of the keytop 1 is described as a square-pole-shaped protrusion having four side surfaces 1c. However, the protrusion 1b does not have to have the shape of a square pole. For example, it may be formed so as to have the shape of a polyhedral pole. A plurality of flat side surfaces are formed along the protrusion, and the actuator 2 is formed with the number of press-contact portions in correspondence with the plurality of side surfaces. These press-contact portions are such as to be press-contacted to the plurality of side surfaces, respectively.

As can be understood from the foregoing description, according to the keyswitch of the present invention, the keytop is held by the actuator, and the elastic members directly elastically bias the keytop. With the upward and downward movement of the keytop, the pair of lever members can move up and down through the actuator. Therefore, the mounting of the pair of lever members to the actuator is simplified, thereby facilitating the automation of the assembly. Therefore, it is possible to provide a low-cost keyswitch.

The top ends of the pair of lever members are mounted to the actuator, so that it is not necessary for the keytop to have mounting portions for mounting the lever members thereto. This simplifies the structure of the keytop. In addition, it makes it unnecessary to use a sophisticated die for forming the keytop by molding, thereby making it possible to considerably reduce the die cost, and, thus, to reduce to cost of the keytop.

The actuator has a dislodging-preventing stopper portion which can prevent the dislodging of the actuator as a result of press-contacting it to the side surfaces provided therearound, with a plurality of press-contact portions supported in a cantilever manner being formed at the dislodging-preventing stopper portion. The keytop is held by the actuator as a result of press-contacting the press-contact portions to the side surfaces at the protrusion. Therefore, by press-fitting the keytop to the dislodging-preventing stopper portion of the actuator, the keytop can be firmly held by the actuator.

Therefore, the force required to pull out the keytop can be made large, so that, even when an operating weight which pushes the keytop obliquely is applied, the keytop is not tilted.

The press-contact portions are formed so as to protrude inwardly from the inner peripheral wall defining the through hole in the actuator in order to be supported in a cantilever manner. In addition, the ends of the press-contact portions are such as to be press-contacted to the corresponding side surfaces at the protrusion. Therefore, it is possible to hold the keytop to the actuator even more firmly, thereby making it possible to increase the force required to pull off the keytop.

The actuator is formed of a metallic plate, the press-contact portions are formed so as to protrude inwardly from the four directions of the inner peripheral wall of the through hole, the keytop is formed of a resin material, the prismatic protrusion is formed with the shape of a square pole, and the press-contact portions are such as to be press-contacted to the four sides along the prismatic protrusion. Therefore, the keytop and the actuator can be easily manufactured, thereby making it possible to reduce costs.

At the square-pole-shaped protrusion is formed a cross-shaped presser portion which protrudes in the diagonal direction from a corner where the side surfaces at the protrusion intersect. The length of the presser portion in the diagonal direction is larger than the sizes of the top portions of the elastic members. In addition, the presser portion is brought into contact with the top portions of the elastic members, so that the elastic members directly elastically bias the keytop. Therefore, the tactile feel produced at the elastic members is directly transmitted to the keytop. Consequently, it is possible to provide a high-quality keyswitch that provides a proper operational feel.

The actuator has a rotation engaging section which has an open portion and which allows the top end of one of the pair of lever members to rotatably engage therewith, and a slide engaging section which has an open portion and which allows the top end of the other lever member to slidably engage therewith, with the open portions of the rotation engaging section and the slide engaging section being formed so as to open in the same direction. Therefore, the top ends of the lever members can engage their corresponding rotation engaging section and the slide engaging section by simply moving the actuator towards one side in the horizontal direction. Therefore, it is possible to provide a key switch whose assembly can be easily automated.

The rotation engaging section is formed at one end of the actuator so as to have a U-shaped side surface. A protrusion is formed near the open portion of the U-shaped rotation engaging section, at either one of or both of the opposing sides thereof. The protrusion or protrusions reduce the width of the open portions. Therefore, the top end of one of the pair of lever members can engage the rotation engaging section from the small-width open portions by a snap-in operation as a result of carrying out a one-touch operation.

Therefore, it is possible to provide a keyswitch that can be easily assembled.

The slide engaging section is formed at the other end of the actuator so as to have a U-shaped side surface. The two opposing sides of the U-shaped slide engaging section are formed parallel to each other. Therefore, it is possible for the top end of one of the lever members to engage the rotation engaging section by a snap-in operation, and the top end of the other lever member to slidably engage the slide engaging section, thereby facilitating assembly.

The actuator is formed of a metallic plate, and the rotation engaging section and the slide engaging section are bent so that they have U-shaped side surfaces. Therefore, the actuator can be produced by, for example, a pressing operation, and a keyswitch having a high-precision actuator can be provided at a low cost.

The strengths of the pair of lever members to which an actuator, formed of a metallic plate, is mounted can be increased.

In the method of assembling a keyswitch in accordance with the present invention, a pushing weight is exerted from one side of the actuator in a direction parallel to the mounting surface thereof in order to mount the actuator to the top ends of the pair of lever members as a result of engaging it therewith. Therefore, the assembly is simplified, and the automation of the assembly is facilitated.

By exerting a pushing weight to the mounting surface of the actuator, the rotation engaging section, formed at one end of the mounting surface, engages the top end of one of the lever members by a snap-in operation, and the slide engaging section, formed at the other end of the mounting surface, is mounted to the top end of the other lever member as a result of slidably engaging it therewith. Therefore, the assembly is further simplified.

What is claimed is:

1. A keyswitch comprising:
a pair of lever members which are rotatably linked at a portion where the lever members cross each other;
a keytop supported by the pair of lever members so as to be movable upward and downward;
an elastic member for elastically biasing the keytop upward; and
a switch element which is subjectable to a switching operation with the upward and downward movement of the keytop;
wherein an actuator is engaged by a top end of each of the pair of lever members;
wherein the keytop is held by the actuator;
wherein the elastic member directly elastically biases the keytop; and
wherein, with the upward and downward movement of the keytop, the pair of lever members are movable upward and downward through the actuator.

2. A keyswitch according to claim 1, wherein a prismatic protrusion is formed at a portion of the keytop that is held by the actuator, and side surfaces formed at a periphery of the prismatic protrusion are formed flat; and wherein the actuator has a dislodging preventing stopper portion capable of preventing the actuator from becoming dislodged by being press-contacted to the side surfaces at the periphery of the protrusion, a plurality of press-contact portions supported in a cantilever manner being provided at the dislodging-preventing stopper portion, and the press-contact portions being press-contacted to the corresponding side surfaces at the protrusion in order to hold the keytop to the actuator.

3. A keyswitch according to claim 2, wherein the press-contact portions are formed so as to be supported in the cantilever manner by causing the press-contact portions to protrude inwardly from an inner peripheral wall defining a hole which passes through the actuator, and ends of the press-contact portions are such as to press-contact the corresponding side surfaces at the protrusion.

4. A keyswitch according to claim 3, wherein the actuator is formed of a metallic plate, and the press-contact portions are formed so as to protrude inwardly from four directions of the inner peripheral wall defining the hole, wherein the keytop is formed of a resin material, and the prismatic protrusion has the shape of a square pole, and wherein the press-contact portions are press-fitted to corresponding four side surfaces at the periphery of the square-pole-shaped protrusion.

5. A keyswitch according to claim 4, wherein the square-pole-shaped protrusion has a cross-shaped presser portion formed so as to protrude in a diagonal direction from a corner where the side surfaces intersect each other, the length of the presser portion in the diagonal direction being greater than the size of a top portion of the elastic member, and the presser portion being brought into contact with the top portion of the elastic member in order for the elastic member to elastically bias the keytop.

6. A keyswitch comprising:
a pair of lever members which are rotatably linked at a portion where the lever members cross each other;
a keytop supported by the pair of lever members so as to be movable upward and downward;
an elastic member for elastically biasing the keytop upward; and
a switch element which is subjectable to a switching operation with the upward and downward movement of the keytop;
wherein a lever mounting plate with which bottom ends of the pair of lever members are engageable is provided, the lever mounting plate being mounted to a holding plate and being placed on the switch element, the lever mounting plate including a rotation engaging section and a slide engaging section, the rotation engaging section having an open portion and allowing the bottom end of one of the lever members to rotatably engage therewith, the slide engaging section having an open portion and allowing the bottom end of the other lever member to slidably engage therewith, the open portion of the rotation engaging section and the open portion of the slide engaging section opening in a same direction.

7. A keyswitch according to claim 6, wherein the lever mounting plate is a metallic plate, the lever mounting plate having a pair of first cut-up portions at one side thereof, the slide engaging section which has the open portion being formed into a U shape at the first cut-up portions, and two opposing sides of the U-shaped slide engaging section being formed parallel to each other.

8. A keyswitch according to claim 6, wherein a pair of second cut-up portions are formed at the other side of the lever mounting plate so as to be separated from the first cut-up portions, the rotation engaging section being formed into a U shape at the second cut-up portions, and a protrusion being formed near the open portion at either one of or both opposing sides of the rotation engaging section, the protrusion being provided to reduce the width of the open portion.

9. A method of assembling a keyswitch, wherein:
a pair of lever members which are rotatably linked at a portion where the lever members cross each other are provided; wherein top ends of the pair of lever members are made movable upward and downward through an actuator with an upward and downward movement of a keytop which is elastically biased by an elastic member; wherein bottom ends of the pair of lever members are made engageable with a lever mounting plate; wherein the bottom ends of the pair of lever members are positioned on the lever mounting member, the pair of lever members are moved from one side to the other, and the bottom ends of the pair of lever members are made to engage the lever mounting plate in order to assemble the keyswitch.

10. A method of assembling a keyswitch according to claim 9, wherein by moving the pair of lever members from one side to the other, the bottom end of one of the lever members engages a rotation engaging section of the lever mounting plate by a snap-in operation so that the one of the lever members is rotatable thereat, and the bottom end of the other lever member is slid and is made to engage a slide engaging section of the lever mounting plate so that the other lever member is slidable thereat.
